(19) United States
(12) Patent Application Publication
(10) Pub. No.: US 2026/0136008 A1
(43) Pub. Date: May 14, 2026

(54) FILTER STRENGTH OR LENGTH DESIGN FOR ASYMMETRIC DEBLOCKING AT VIRTUAL BOUNDARIES

(71) Applicant: Nokia Technologies Oy, Espoo (FI)

(72) Inventors: Seungwook HONG, San Diego, CA (US); Limin WANG, San Diego, CA (US); Krit PANUSOPONE, San Diego, CA (US)

(21) Appl. No.: 19/119,642

(22) PCT Filed: Aug. 29, 2023
(86) PCT No.: PCT/EP2023/073658

§ 371 Date: Apr. 9, 2025

Related U.S. Application Data
(60) Provisional application No. 63/379,074, filed on Oct. 11, 2022.

(51) Int. Cl. H04N 19/119; H04N 19/117; H04N 19/136; H04N 19/172; H04N 19/176; H04N 19/182

(52) U.S. Cl. CPC H04N 19/119; H04N 19/117; H04N 19/136; H04N 19/172; H04N 19/176; H04N 19/182

(57) ABSTRACT

An apparatus including at least one processor; and at least one memory storing instructions that, when executed with the at least one processor, cause the apparatus to: determine a virtual boundary that separates a picture, or a portion of the picture, into a first area and a second area; and determine to perform filtering of at least one pixel of the first area and not perform filtering of pixels of the second area; and filter the at least one pixel of the first area with coding information of the second area.

### BACKGROUND

### Technical Field

The example and non-limiting embodiments relate generally to video coding and, more particularly, to virtual boundaries.

### Brief Description of Prior Developments

Versatile Video Coding (VVC) has the concept of virtual boundaries. A picture may be divided into different regions by virtual boundaries from a coding dependency perspective.

### SUMMARY

The following summary is merely intended to be an example. The summary is not intended to limit the scope of the claims.

In accordance with one aspect, an example apparatus is provided comprising: at least one processor; and at least one memory storing instructions that, when executed with the at least one processor, cause the apparatus to: determine a virtual boundary that separates a picture, or a portion of the picture, into a first area and a second area; and determine to perform filtering of at least one pixel of the first area and not perform filtering of pixels of the second area; and filter the at least one pixel of the first area with coding information of the second area.

In accordance with another aspect, an example method is provided comprising: determining a virtual boundary that separates a picture, or a portion of the picture, into a first area and a second area; and determining to perform filtering of at least one pixel of the first area and not perform filtering of pixels of the second area; and filtering of the at least one pixel of the first area with coding information of the second area.

In accordance with another aspect, an example embodiment is provided with a non-transitory computer readable medium comprising program instructions that, when executed with an apparatus, cause the apparatus to perform at least the following: determining a virtual boundary that separates a picture, or a portion of the picture, into a first area and a second area; and determining to perform filtering of at least one pixel of the first area and not perform filtering of pixels of the second area; and filtering of the at least one pixel of the first area with coding information of the second area.

In accordance with another aspect, an example apparatus is provided comprising: means for determining a virtual boundary that separates a picture, or a portion of the picture, into a first area and a second area; and means for determining to perform filtering of at least one pixel of the first area and not perform filtering of pixels of the second area; and means for filtering of the at least one pixel of the first area with coding information of the second area.

### BRIEF DESCRIPTION OF THE DRAWINGS

The foregoing aspects and other features are explained in the following description, taken in connection with the accompanying drawings, wherein:

The foregoing aspects and other features are explained in the following description, taken in connection with the accompanying drawings, wherein:

FIG. 1 shows schematically an electronic device employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 shows schematically a block chart of an encoder used for data compression on a general level.

FIG. 5 illustrates that a refreshed are is not allowed to use coding information of a non-refreshed area.

FIG. 6 illustrates that a non-refreshed area is allowed to use coding information of a refreshed area.

FIG. 7 illustrates two transform blocks which are horizontally neighbored with a vertical boundary at the TransformEdge.

FIG. 8 illustrates a transform blocks with sub-blocks, a TransformEdge, Subblock Edges, sizes and relationships.

FIG. 9 is a diagram illustrating a filter strength (or length) decision for a luma component which may be used for two transform blocks located on opposite sides of a virtual boundary.

FIG. 10 is a diagram illustrating one example of a filter strength (or length) decision for a luma component, which shows modification relative to the diagram shown in FIG. 9, which may be used for one transform block located on one side of a virtual boundary.

FIG. 11 is a diagram illustrating a filter strength (or length) decision for a chroma component which may be used for two transform blocks located on opposite sides of a virtual boundary.

FIG. 12 is a diagram illustrating one example of a filter strength (or length) decision for a chroma component, which shows modification relative to the diagram shown in FIG. 11, which may be used for one transform block located on one side of a virtual boundary.

FIG. 13 is a diagram illustrating one example method.

### DETAILED DESCRIPTION

Described herein is an example regarding an asymmetric in-loop filter at a virtual boundary. The models described herein may be used to perform any task, such as data compression, data decompression, video compression, video decompression, image or video classification, object classification, object detection, object tracking, speech recognition, language translation, music transcription, etc.

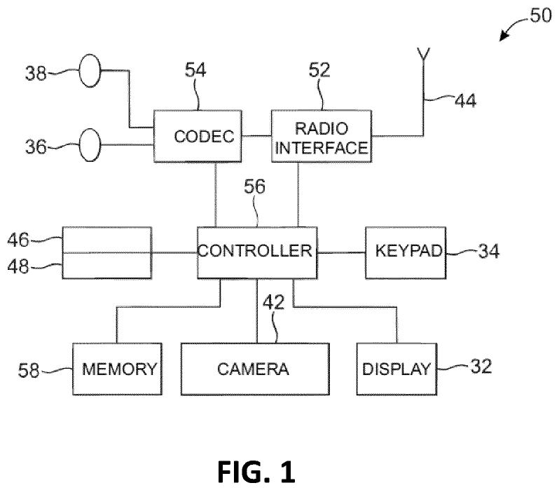

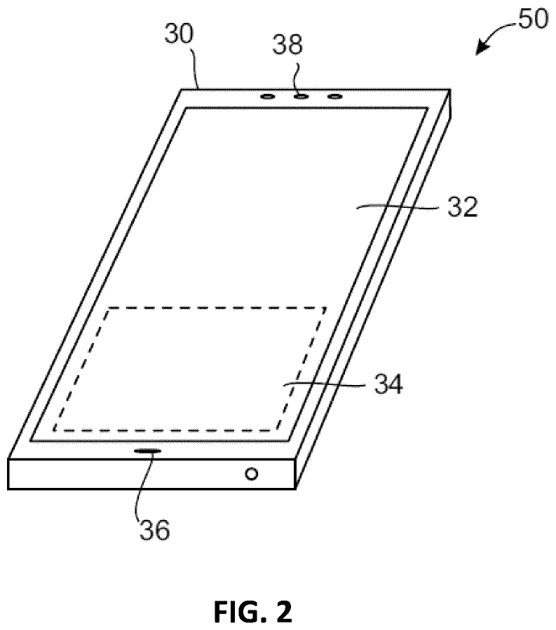

The following describes in detail a suitable apparatus and possible mechanisms to implement aspects of asymmetric in-loop filters at virtual boundaries. In this regard reference is first made to FIG. 1 and FIG. 2, where FIG. 1 shows an example block diagram of an apparatus 50. The apparatus may be an Internet of Things (IoT) apparatus configured to perform various functions, such as for example, gathering information by one or more sensors, receiving or transmitting information, analyzing information gathered or received by the apparatus, or the like. The apparatus may comprise a neural network weight update coding system, which may incorporate a codec. FIG. 2 shows a layout of an apparatus according to an example embodiment. The elements of FIG. 1 and FIG. 2 are explained next.

The electronic device 50 may for example be a mobile terminal or user equipment of a wireless communication system, a sensor device, a tag, or other lower power device. Alternatively, the electronic device may be a computer or part of a computer that is not mobile. However, it would be appreciated that embodiments of the examples described herein may be implemented within any electronic device or apparatus which may process data.

The apparatus 50 may comprise a housing 30 for incorporating and protecting the device. The apparatus 50 further may comprise a display 32 in the form of a liquid crystal display. In other embodiments of the examples described herein the display may be any suitable display technology suitable to display an image or video. The apparatus 50 may further comprise a keypad 34 (or touch area 34). In other embodiments of the examples described herein any suitable data or user interface mechanism may be employed. For example the user interface may be implemented as a virtual keyboard or data entry system as part of a touch-sensitive display.

The apparatus may comprise a microphone 36 or any suitable audio input which may be a digital or analog signal input. The apparatus 50 may further comprise an audio output device which in embodiments of the examples described herein may be any one of: an earpiece 38, speaker, or an analog audio or digital audio output connection. The apparatus 50 may also comprise a battery (or in other embodiments of the examples described herein the device may be powered by any suitable mobile energy device such as solar cell, fuel cell or clockwork generator). The apparatus may further comprise a camera 42 capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56, processor or processor circuitry for controlling the apparatus 50. The controller 56 may be connected to memory 58 which in embodiments of the examples described herein may store both data in the form of image and audio data and/or may also store instructions for implementation on the controller 56. The controller 56 may further be connected to codec circuitry 54 suitable for carrying out coding/compression of neural network weight updates and/or decoding of audio and/or video data or assisting in coding and/or decoding carried out by the controller.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) such as a network node, and/or for receiving radio frequency signals from other apparatus(es).

The apparatus 50 may comprise a camera capable of recording or detecting individual frames which are then passed to the codec 54 or the controller for processing. The apparatus may receive the video image data or machine learning data for processing from another device prior to transmission and/or storage. The apparatus 50 may also receive either wirelessly or by a wired connection the image for coding/decoding. The structural elements of apparatus 50 described above represent examples of means for performing a corresponding function.

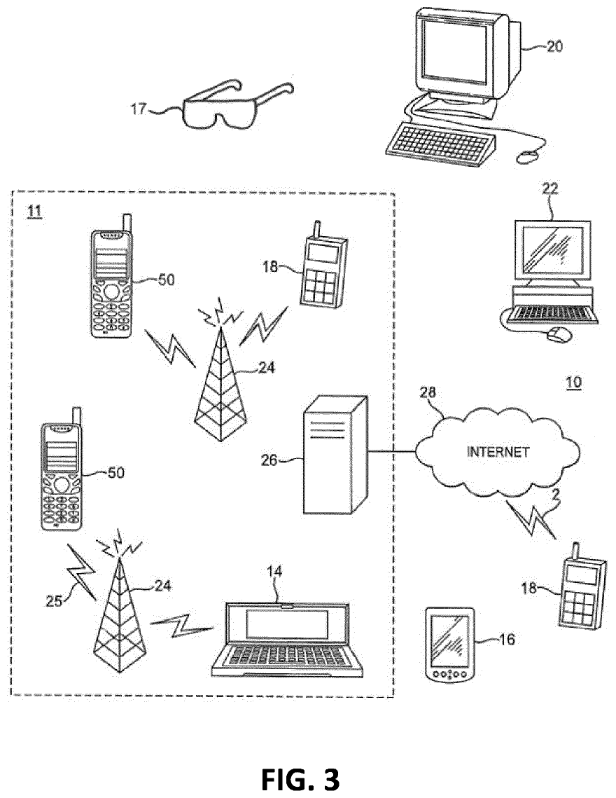

With respect to FIG. 3, an example of a system within which embodiments of the examples described herein can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA, LTE, 4G, 5G network etc.), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices and/or apparatus 50 suitable for implementing embodiments of the examples described herein.

For example, the system shown in FIG. 3 shows a mobile telephone network 11 and a representation of the internet 28, which is accessible to the various devices shown in FIG. 3 using communication link 2 (wired or wireless). Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport, or a head mounted display (HMD) 17.

The embodiments may also be implemented in a set-top box: i.e. a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IoT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The Internet of Things (IoT) may be defined, for example, as an interconnection of uniquely identifiable embedded computing devices within the existing Internet infrastructure. The convergence of various technologies has and may enable many fields of embedded systems, such as wireless sensor networks, control systems, home/building automation, etc. to be included in the Internet of Things (IoT). In order to utilize the Internet IoT devices are provided with an IP address as a unique identifier. IoT devices may be provided with a radio transmitter, such as a WLAN or Bluetooth transmitter or a RFID tag. Alternatively, IoT devices may have access to an IP-based network via a wired network, such as an Ethernet-based network or a power-line connection (PLC).

One application where asymmetric in-loop filters at virtual boundaries and model level update skipping in compressed incremental learning is important, is the use case of neural network based codecs, such as neural network based video codecs. Video codecs may use one or more neural networks. In a first case, the video codec may be a conventional video codec such as the Versatile Video Codec (VVC/H.266) that has been modified to include one or more neural networks. Examples of these neural networks are:
1. a neural network filter to be used as one of the in-loop filters of VVC
2. a neural network filter to replace one or more of the in-loop filter(s) of VVC
3. a neural network filter to be used as a post-processing filter
4. a neural network to be used for performing intra-frame prediction
5. a neural network to be used for performing inter-frame prediction.

In a second case, which is usually referred to as an end-to-end learned video codec, the video codec may comprise a neural network that transforms the input data into a more compressible representation. The new representation may be quantized, lossless compressed, then lossless decompressed, dequantized, and then another neural network may transform its input into reconstructed or decoded data.

In both of the above two cases, there may be one or more neural networks at the decoder-side, and consider the example of one neural network filter. The encoder may finetune the neural network filter by using the ground-truth data which is available at encoder side (the uncompressed data). Finetuning may be performed in order to improve the neural network filter when applied to the current input data, such as to one or more video frames. Finetuning may comprise running one or more optimization iterations on some or all the learnable weights of the neural network filter. An optimization iteration may comprise computing gradients of a loss function with respect to some or all the learnable weights of the neural network filter, for example by using the backpropagation algorithm, and then updating the some or all learnable weights by using an optimizer, such as the stochastic gradient descent optimizer. The loss function may comprise one or more loss terms. One example loss term may be the mean squared error (MSE). Other distortion metrics may be used as the loss terms. The loss function may be computed by providing one or more data to the input of the neural network filter, obtaining one or more corresponding outputs from the neural network filter, and computing a loss term by using the one or more outputs from the neural network filter and one or more ground-truth data. The difference between the weights of the finetuned neural network and the weights of the neural network before finetuning is referred to as the weight-update. This weight-update needs to be encoded, provided to the decoder side together with the encoded video data, and used at the decoder side for updating the neural network filter. The updated neural network filter is then used as part of the video decoding process or as part of the video post-processing process. It is desirable to encode the weight-update such that it requires a small number of bits. Thus, the examples described herein consider also this use case of neural network based codecs as a potential application of the compression of weight-updates.

In further description of the neural network based codec use case, an MPEG-2 transport stream (TS), specified in ISO/IEC 13818-1 or equivalently in ITU-T Recommendation H.222.0, is a format for carrying audio, video, and other media as well as program metadata or other metadata, in a multiplexed stream. A packet identifier (PID) is used to identify an elementary stream (a.k.a. packetized elementary stream) within the TS. Hence, a logical channel within an MPEG-2 TS may be considered to correspond to a specific PID value.

Available media file format standards include ISO base media file format (ISO/IEC 14496-12, which may be abbreviated ISOBMFF) and file format for NAL unit structured video (ISO/IEC 14496-15), which derives from the ISOBMFF.

A video codec consists of an encoder that transforms the input video into a compressed representation suited for storage/transmission and a decoder that can decompress the compressed video representation back into a viewable form. A video encoder and/or a video decoder may also be separate from each other, i.e. need not form a codec. Typically the encoder discards some information in the original video sequence in order to represent the video in a more compact form (that is, at lower bitrate).

Typical hybrid video encoders, for example many encoder implementations of ITU-T H.263 and H.264, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

In temporal prediction, the sources of prediction are previously decoded pictures (a.k.a. reference pictures). In intra block copy (IBC: a.k.a. intra-block-copy prediction and current picture referencing), prediction is applied similarly to temporal prediction but the reference picture is the current picture and only previously decoded samples can be referred in the prediction process. Inter-layer or inter-view prediction may be applied similarly to temporal prediction, but the reference picture is a decoded picture from another scalable layer or from another view, respectively. In some cases, inter prediction may refer to temporal prediction only, while in other cases inter prediction may refer collectively to temporal prediction and any of intra block copy, inter-layer prediction, and inter-view prediction provided that they are performed with the same or similar process as temporal prediction. Inter prediction or temporal prediction may sometimes be referred to as motion compensation or motion-compensated prediction.

Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in the spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

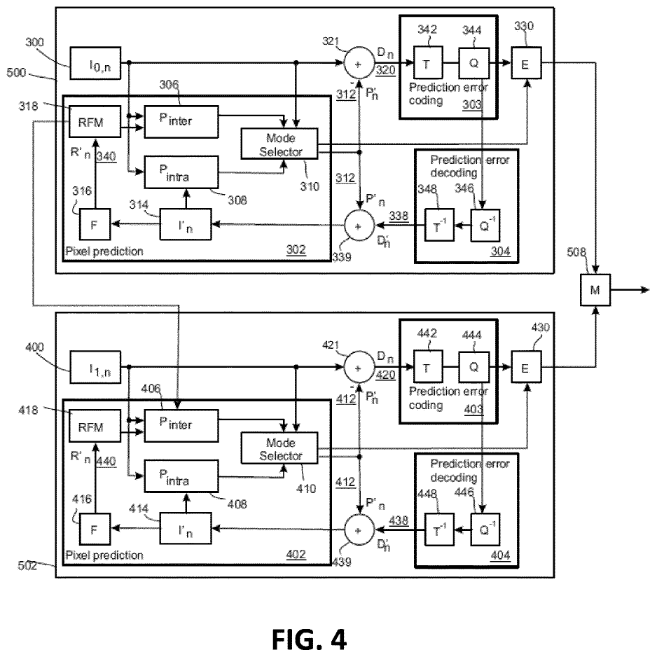

FIG. 4 shows a block diagram of a general structure of a video encoder. FIG. 4 presents an encoder for two layers, but it would be appreciated that presented encoder could be similarly extended to encode more than two layers. FIG. 4 illustrates a video encoder comprising a first encoder section 500 for a base layer and a second encoder section 502 for an enhancement layer. Each of the first encoder section 500 and the second encoder section 502 may comprise similar elements for encoding incoming pictures. The encoder sections 500, 502 may comprise a pixel predictor 302, 402, prediction error encoder 303, 403 and prediction error decoder 304, 404. FIG. 4 also shows an embodiment of the pixel predictor 302, 402 as comprising an inter-predictor 306, 406 (Pinter), an intra-predictor 308, 408 (Pᵢₙₜᵣₐ), a mode selector 310, 410, a filter 316, 416 (F), and a reference frame memory 318, 418 (RFM). The pixel predictor 302 of the first encoder section 500 receives 300 base layer images (I_{0,n}) of a video stream to be encoded at both the inter-predictor 306 (which determines the difference between the image and a motion compensated reference frame 318) and the intra-predictor 308 (which determines a prediction for an image block based only on the already processed parts of the current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the base layer picture 300. Correspondingly, the pixel predictor 402 of the second encoder section 502 receives 400 enhancement layer images (I_{1,n}) of a video stream to be encoded at both the inter-predictor 406 (which determines the difference between the image and a motion compensated reference frame 418) and the intra-predictor 408 (which determines a prediction for an image block based only on the already processed parts of the current frame or picture). The output of both the inter-predictor and the intra-predictor are passed to the mode selector 410. The intra-predictor 408 may have more than one intra-prediction modes. Hence, each mode may perform the intra-prediction and provide the predicted signal to the mode selector 410. The mode selector 410 also receives a copy of the enhancement layer picture 400.

Depending on which encoding mode is selected to encode the current block, the output of the inter-predictor 306, 406 or the output of one of the optional intra-predictor modes or the output of a surface encoder within the mode selector is passed to the output of the mode selector 310, 410. The output of the mode selector is passed to a first summing device 321, 421. The first summing device may subtract the output of the pixel predictor 302, 402 from the base layer picture 300/enhancement layer picture 400 to produce a first prediction error signal 320, 420 (Dₙ) which is input to the prediction error encoder 303, 403.

The pixel predictor 302, 402 further receives from a preliminary reconstructor 339, 439 the combination of the prediction representation of the image block 312, 412 (P′ₙ) and the output 338, 438 (D′ₙ) of the prediction error decoder 304, 404. The preliminary reconstructed image 314, 414 (I′ₙ) may be passed to the intra-predictor 308, 408 and to the filter 316, 416. The filter 316, 416 receiving the preliminary representation may filter the preliminary representation and output a final reconstructed image 340, 440 (R′ₙ) which may be saved in a reference frame memory 318, 418. The reference frame memory 318 may be connected to the inter-predictor 306 to be used as the reference image against which a future base layer picture 300 is compared in inter-prediction operations. Subject to the base layer being selected and indicated to be the source for inter-layer sample prediction and/or inter-layer motion information prediction of the enhancement layer according to some embodiments, the reference frame memory 318 may also be connected to the inter-predictor 406 to be used as the reference image against which a future enhancement layer picture 400 is compared in inter-prediction operations. Moreover, the reference frame memory 418 may be connected to the inter-predictor 406 to be used as the reference image against which a future enhancement layer picture 400 is compared in inter-prediction operations.

Filtering parameters from the filter 316 of the first encoder section 500 may be provided to the second encoder section 502 subject to the base layer being selected and indicated to be the source for predicting the filtering parameters of the enhancement layer according to some embodiments.

The prediction error encoder 303, 403 comprises a transform unit 342, 442 (T) and a quantizer 344, 444 (Q). The transform unit 342, 442 transforms the first prediction error signal 320, 420 to a transform domain. The transform is, for example, the DCT transform. The quantizer 344, 444 quantizes the transform domain signal, e.g. the DCT coefficients, to form quantized coefficients.

The prediction error decoder 304, 404 receives the output from the prediction error encoder 303, 403 and performs the opposite processes of the prediction error encoder 303, 403 to produce a decoded prediction error signal 338, 438 which, when combined with the prediction representation of the image block 312, 412 at the second summing device 339, 439, produces the preliminary reconstructed image 314, 414. The prediction error decoder 304, 404 may be considered to comprise a dequantizer 346, 446 (Q⁻¹), which dequantizes the quantized coefficient values, e.g. DCT coefficients, to reconstruct the transform signal and an inverse transformation unit 348, 448 (T⁻¹), which performs the inverse transformation to the reconstructed transform signal wherein the output of the inverse transformation unit 348, 448 contains reconstructed block(s). The prediction error decoder may also comprise a block filter which may filter the reconstructed block(s) according to further decoded information and filter parameters.

The entropy encoder 330, 430 (E) receives the output of the prediction error encoder 303, 403 and may perform a suitable entropy encoding/variable length encoding on the signal to provide error detection and correction capability. The outputs of the entropy encoders 330, 430 may be inserted into a bitstream e.g. by a multiplexer 508 (M).

The concept of virtual boundaries was introduced in VVC. A picture may be divided into different regions by virtual boundaries from a coding dependency perspective. For example, 360°: virtual boundaries are used to define the boundaries of different faces of a 360° picture in CMP format, and GDR (with reference to U.S. provisional application No. 63/296,590, filed in January 2022, entitled “New Gradual Decoding Refresh for ECM”, which is hereby incorporated by reference in its entirety, where a virtual boundary separates the refreshed area and non-refreshed area of a GDR/recovering picture. In VVC, virtual boundaries are specified in a SPS and/or a picture header.

There are three in-loop filters in VVC. They are deblocking, SAO and ALF. ECM enhances the in-loop filters with new features, including Bilateral (JVET-F0034, JVET-V0094), BIF for chroma (JVET-X0067), CCSAO (JVET-V0153, JVET-Y0106), CCALF (JVET-X0045), and Alternative band classifier for ALF (JVET-X0070), and CCSAO EDGE classifier (JVET-Y0106).

In-loop filtering of a current pixel often requires use of coding information of its neighbors. Hence, filtering on one side of a virtual boundary may involve use of coding information on other side of the virtual boundary.

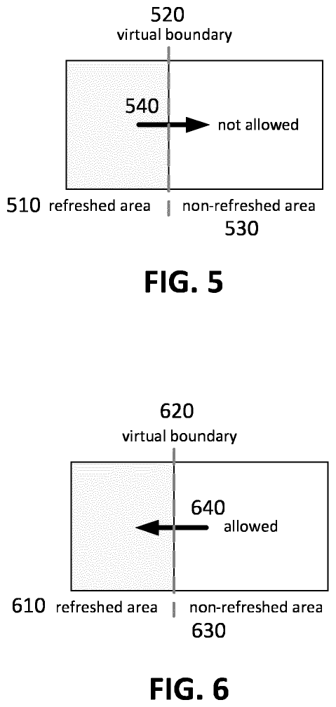

For some applications, it is not desirable or may not be allowed to have in-loop filtering cross a virtual boundary. For example, in GDR, a GDR/recovering picture may be divided into a refreshed area and a non-refreshed area by a virtual boundary. Referring to FIG. 5, to avoid leaks, the refreshed area 510 cannot use any information of non-refreshed area 530, because there is no guarantee that the non-refreshed area 530 is decoded correctly at the decoder. Incorrectly decoded coding information may contaminate the refreshed area 510, which may result in leaks or mismatch of the encoder and decoder at recovery point pictures and successive pictures. Hence, for a GDR/recovering picture, in-loop filtering cannot cross the virtual boundary 520 from refreshed area 510 to non-refreshed area 530, as indicated by the arrow 540.

On the other hand, sometimes it is perfectly fine to let in-loop filtering cross a virtual boundary. For example, as shown in FIG. 6, in the same example of GDR, the non-refreshed area 630 can use information of refreshed area 610. Hence, for a GDR/recovering picture, in-loop filtering can cross the virtual boundary 620 from non-refreshed area 630 to refreshed area 610, as indicated by the arrow 640.

In the current designs of VVC and ECM, in-loop filtering cannot cross virtual boundaries.

U.S. provisional application No. 63/362,243, “In-Loop Filtering at Virtual Boundaries”, filed on March 2022, which is hereby incorporated by reference in its entirety, proposed several possible options of in-loop filtering at virtual boundaries. Among them is asymmetric in-loop filtering at a virtual boundary. With this asymmetric option, in-loop filtering cannot cross a virtual boundary from one side of the virtual boundary to the other side of the virtual boundary, but can from the other side to the one side.

Specifically, in-loop filtering of one side A of a virtual boundary cannot use information of the other side B of the virtual boundary, but in-loop filtering of the other side B of the virtual boundary can use information of the one side A. If in-loop filtering for a pixel in the one side A of the virtual boundary requires use of any information (e.g. pixels, coding mode, QP, etc.) of the other side B, in-loop filtering is either: not performed for the pixel, or still performed for the pixel, but with padding the information of the other side.

With asymmetric in-loop filtering at a virtual boundary, in-loop filtering of one side A cannot use information of other side B, but in-loop filtering of the other side B is allowed to use information of the one side A.

In-loop filtering of a pixel in the one side A may not be performed normally if in-loop filtering of the pixel requires use of coding information of the other side B.

In general, in-loop filtering of a pixel in the other side B can be performed normally because in-loop filtering of the pixel is allowed to use the coding information of both the one side A and the other side B. But, the other side B may choose not to use the coding information of the one side A, in which case, in-loop filtering of a pixel in the other side B may not be performed normally if in-loop filtering of the pixel requires use of coding information of the one side A.

Since the coding information of the one side A is available for the other side B, an offset based upon in-loop filtering of the one side A may be added to the output of in-loop filtering of the other side B.

A virtual boundary is a line, that is used to separate a picture, or a portion of a picture, into two areas: a first area and a second area.

A virtual boundary can be vertical or horizontal. In VVC and ECM, virtual boundary syntax is included in the SPS and/or picture header. In one embodiment, such as with asymmetric operation at a virtual boundary, the first area is not allowed to use any information of the second area, but the second area can use the information of the first area.

In one example embodiment, in a GDR/recovering picture, the first area is a clean (refreshed) area and the second area is a dirty (non-refreshed) area. The clean (refreshed) area cannot use any information of the dirty (non-refreshed) area, but the dirty (non-refreshed) area can use information of the clean (refreshed) area.

In-loop filtering for a pixel may involve in use of coding information of its neighbors.

If in-loop filtering of a pixel in the first area requires use of coding information (e.g. pixels, coding mode, reference picture, MV, QP, etc.) of the second area, in-loop filtering of the pixel may not be performed normally. Actual in-loop filtering for the pixel may take one of two possible options, option 1 where in-loop filtering for the pixel in the first area is not performed, or option 2 where in-loop filtering for the pixel in the first area is still performed, but with the coding information of the second area derived from the first area, or set to pre-determined values, when needed.

One embodiment related to option 2 is that if in-loop filtering of a pixel in the first area requires use of pixels in the second area, the pixels in the second area are padded from the pixels in the first area.

Another embodiment related to option 2 is that if in-loop filtering of a pixel in the first area requires use of pixels in the second area, the pixels in the second area are replaced by the pixels extrapolated from the first area.

Let normal in-loop filtering of a pixel be ideal in-loop filtering of the pixel with using all the necessary information, and actual in-loop filtering of a pixel be practical in-loop filtering of the pixel with or without using all the necessary information.

Actual in-loop filtering of a pixel in either option 1 or 2 generates an output that may be different from the normal in-loop filtering of the pixel which can use the coding information of both the first area and the second area.

In-loop filtering for pixels in the second area can generally be performed normally because in-loop filtering for pixels in the second area is allowed to use the coding information of both the first area and the second area.

U.S. provisional application No. 63/388,385, filed on Jul. 12, 2022, entitled “Asymmetric In-Loop Filters At Virtual Boundaries”, which is hereby incorporated by reference in its entirety, describes:
determining to perform filtering of a pixel of a first area with coding information of a second area derived from the first area or with the coding information of the second area set to a value, when the coding information of the second area is to be used to perform the filtering of the pixel of the first area, or
determining to not perform the filtering of the pixel of the first area, when the coding information of the second area is to be used to perform the filtering of the pixel of the first area.

Features as described herein may be used to refine the design of asymmetric deblocking filter at virtual boundary. Specifically, Features as described herein may be used to provide a longer filter length and more pixels to be filtered.

In VVC (and also in AVC and HEVC), a deblocking process may be performed at a TU (Transform Unit) and/or at a subblock boundary. The purpose of deblocking is to smooth the block boundaries and remove blocky artifacts at the block boundaries.

Deblocking filter design comprises two main processes. The two main processes are filter strength (or length) decision and actual filtering process. Below is a short summary of the filter length decision of deblocking design.

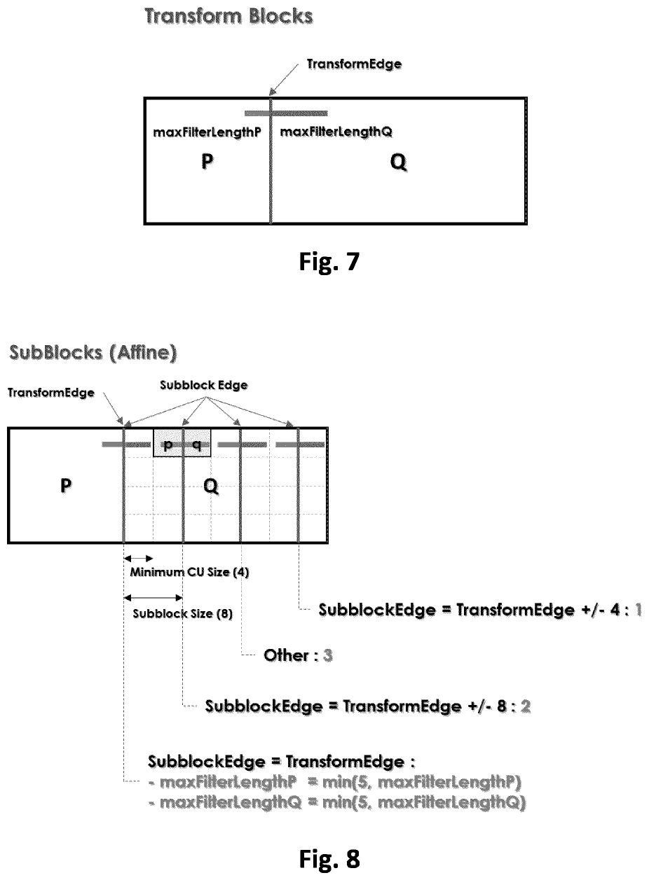

Two TUs may be adjoined horizontally or vertically, and deblocking may be performed over their vertical or horizontal boundary. FIG. 7 shows an example where two TUs of P and Q are horizontally neighbored and, therefore, their vertical boundary may be deblocking filtered. As noted above, in an alternate example the neighboring blocks could be vertically neighboring and, thus, have a horizontal boundary.

The max filter length for luma component of TU P or Q may be determined based upon the size (width or height) of luma component of TUs P or Q. An example is shown in Table 1 below.

TABLE 1
Max Filter Length for Luma Component of P or Q

| P or Q | maxFilterLengthP/Q |
|---|---|
| 32 ≤ size | 7 |
| 8 ≤ size < 32 | 3 |
| others | 1 |

The max filter length for chroma components of TUs P and Q may be determined based upon the sizes (width or height) of chroma components of TUs P and Q. An example is shown in Table 2 below.

TABLE 2
Max Filter Length for Chroma Component of P and Q

| P and Q | maxFilterLengthP/Q |
|---|---|
| 8 ≤ size | 3 |
| others | 1 |

A TU may cover a group of subblocks, and deblocking may be performed over subblock boundaries within the TU. FIG. 8 shows an example where two TUs of P and Q are horizontally neighbored and Q contains subblocks. Those subblock boundaries may also be deblocking filtered.

With the example shown in FIG. 8, inside TU Q, subblocks of p and q are shown which are horizontally neighbored and their vertical boundary may be deblocking filtered. The max filter length for a subblock boundary may be determined based upon distance between the subblock boundary to the associated TU boundaries. An example is shown in Table 3 below.

TABLE 3
Max Filter Length for Boundary of Subblocks p and q

| Distance from | |
|---|---|
| TU boundary | maxFilterLengthp/q |
| 0 | min (5, maxFilterLengthP/Q) |
| 4 | 1 |
| 8 | 2 |
| >8 | 3 |

For simplicity, in the following, the term of block P is used to mean both TU P and subblock p, and the term of block Q is used to mean both TU Q and subblock q. The max filter lengths of blocks P and Q (maxFilterLengthP and maxFilterLengthQ) from a table, such as the example Table 3 for example, may then be used to determine which pixels on each side of P and Q to be filtered.

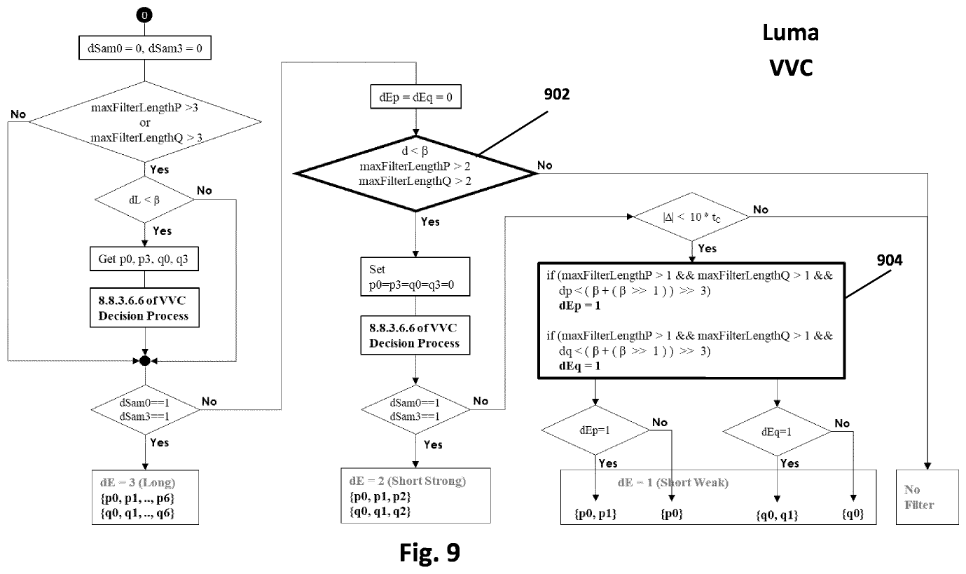

FIG. 9 illustrates a simplified flowchart of a filter strength (or length) decision for luma components of blocks P and Q, where pi, i=0, 1, . . . , 6, are the pixels on P side and qi, i=0, 1, . . . , 6, are the pixels on Q side, and the index i associated with a pixel indicates the distance of the pixel from block boundary. The smaller the pixel index i is, the closer the pixel is to the boundary of blocks P and Q.

As seen in the flowchart, there are a few places 902, 904 checking if both maxFilterLengthP and maxFilterLengthQ are greater than certain values such as, for example, greater than the value 2 and greater than the value 1. If yes, more pixels on each side of P and Q will be filtered. Otherwise, fewer pixels (or even no pixels) on each side of P and Q will be filtered, as illustrated in FIG. 9.

For asymmetric deblocking at a virtual boundary, the actual filtering process may not be performed on a first one side of the virtual boundary, but only be performed on the second other side of the virtual boundary. Note that the first one side may still be filtered, but with padding such as described in U.S. Provisional Patent Application No. 63/362,243 for example.

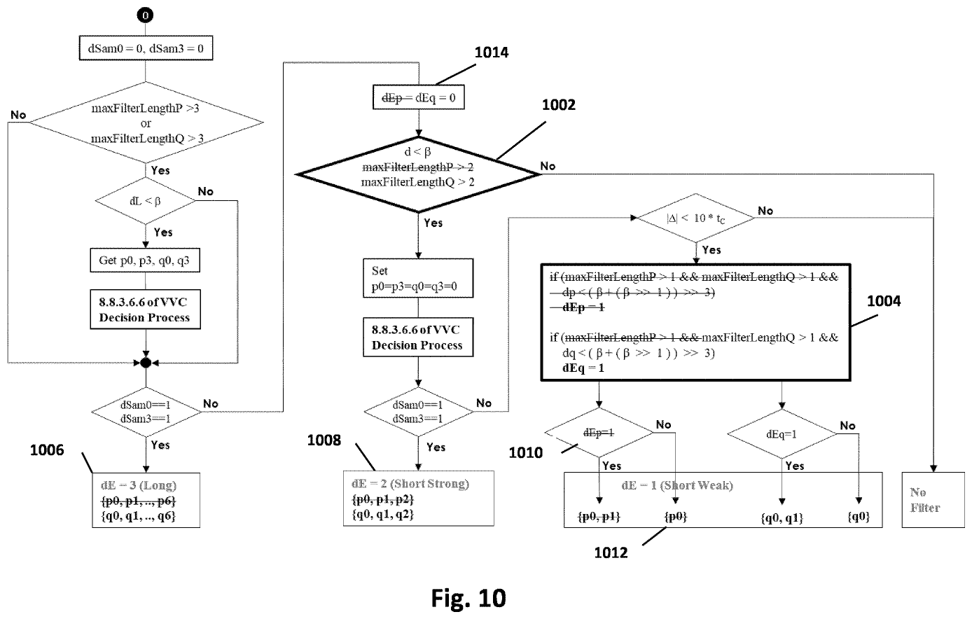

In the following, it is assumed that blocks P and Q are neighbored, and their block boundary are aligned with a virtual boundary, and the actual filtering process is performed only on the Q side: not on the P side. For example, in GDR case, block P may be in a refreshed area and block Q is in a non-refreshed area. Thus, it may be determined to perform filtering on the Q side and not perform filtering on the P side. Actual deblocking filter may be performed only for the pixels on the Q side of the virtual boundary, but not for the pixels on the P side of the virtual boundary. The encoder and the decoder may need to agree which side is filtered and which side is not filtered, such as with the GDR case for example. If P side is not filtered and Q side is filtered, some variables on P side may still need to be calculated and they may be used for Q side. Since P side is not filtered, as further understood below with regard to FIG. 10, the filter length decision for P side may be removed.

From the flowchart of FIG. 9, it should be observed that checking of maxFilterLengthP may affect the number of pixels on the Q side to be filtered.

With one example embodiment and method for asymmetric deblocking at a virtual boundary, the method shown in FIG. 9 may be modified such that the max filter length on one side of the virtual boundary shall not result in fewer pixels on other side of the virtual boundary to be filtered. If checking of the max filter length on the one side of a virtual boundary would result in fewer pixels on the other side of the virtual boundary to be filtered, that checking may be removed from filter strength (or length) decision process on the other side. FIG. 10 shows one example of a proposed flowchart illustrating this modified method. In FIG. 10 the example embodiment shows a flowchart of filter strength (or length) decision for a luma component on a Q side of a virtual boundary. As seen with comparing FIG. 10 to FIG. 9, checking of maxFilterLengthP has been removed in a few places where it may result in fewer pixels on the Q side to be filtered. 1002, compared to 902, has maxFilterLengthP>2 removed. 1004, compared to 904, has the step reduced to “if(maxFilterLengthQ>1 && dq<(β+(β>>1))>>3) dEp=1”. Other portions of the method are modified to take out the P side related steps as indicated by the cross-throughs in 1006, 1008, 1010, 1012 and 1014. With this example proposed flowchart method, more pixels tend to be filtered on Q side. Impact of P side on the Q side may be avoided. P side may not be filtered. Max filter length of P may be compared against specific numbers (e.g. 3, 2, 1 as shown in FIG. 9), but not compared to the max filter length of Q. The decision of comparing max filter length of P against 3, 2, and/or 1 has impact on the filter length for Q. If the impact can potentially cause fewer pixels on Q side to be filtered, the associated comparing of max filter length of P against 3, 2, and 1 is removed for filter strength decision for Q. For example, in FIG. 10, we removed such comparisons in 1002 and 1004, because these two comparisons could result in fewer pixels in Q to be filtered. At the beginning of the flowchart (FIG. 10), there is another comparison of max filter length of P against 3. But, this comparison will not cause fewer pixels of Q to be filtered. So, we still keep it in the flowchart.

Since max filter length of P is not compared to max filter length of Q, the claims may need to be modified accordingly.

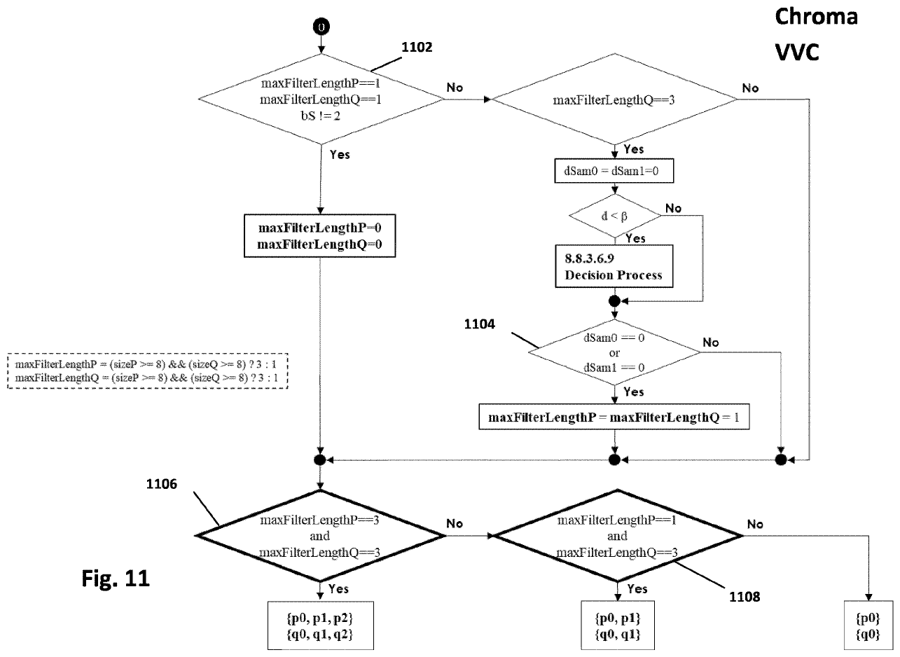

FIG. 11 shows a simplified flowchart of filter strength (or length) decision for chroma components of blocks P and Q. As seen in this example, there are a few places in the flowchart, where maxFilterLengthP may affect the filter strength (or length) decision on the Q side.

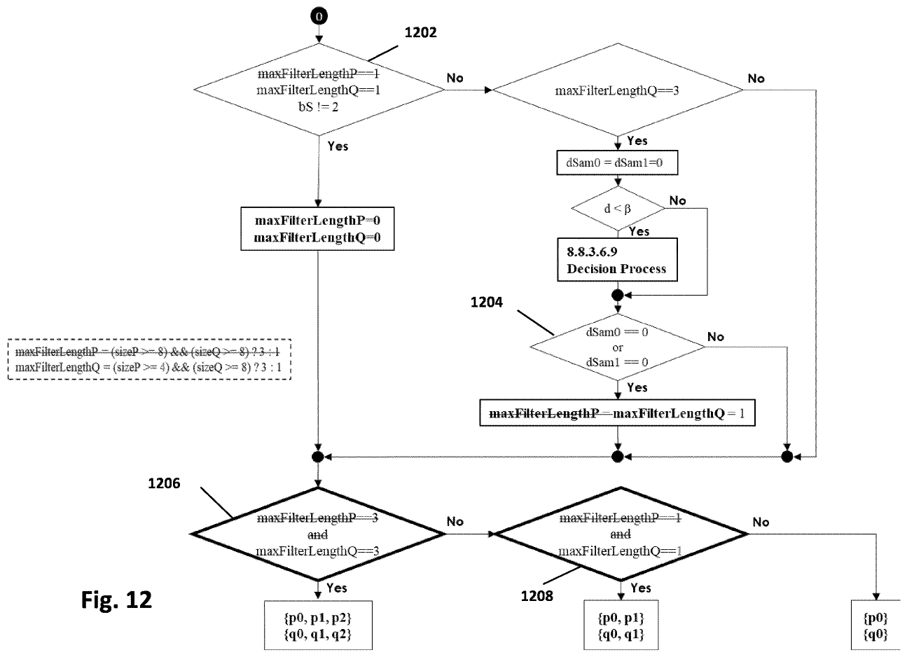

Similar to FIG. 11, FIG. 12 shows the proposed modified flowchart of filter strength (or length) decision for chroma components on Q side of a virtual boundary, in which checking of maxFilterLengthP is removed from filter strength (or length) decision on Q side. 1102 has been changed to 1202 where maxFilterLengthP=1 has been removed. 1104 has been changed to 1204 where “maxFilterLengthP-maxFilterLengthQ=1” has been changed to remove maxFilterLengthP=1 and merely have maxFilterLengthQ=1. 1106 has been changed to 1206 where “maxFilterLengthP==3 and maxFilterLengthQ==3” has been changed to merely “maxFilterLengthQ==3”. 1108 has been changed to 1208 where “maxFilterLengthP==1” has been removed. In addition, the last condition check of maxFilterLengthQ changes from

$$max FliterLengthQ == 3$$

$$max FliterLengthQ == 1$$

The width and/or height of a chroma block may be as small as 2 pixels, and actual filtering of the Q side may require to use up to 3 pixels on the P side. Stated another way, block P can be as small as 2×2 pixels, and filtering of horizontal pixels in block Q may require up to three horizontal pixels from block P. However, since block P has only two horizontal pixels, this creates a problem. To avoid the case that actual filtering of the Q side requires three pixels from block P of only 2 pixels (width or height)), it is further proposed to change max filter length of Q side from

$$max FilterLengthQ = ( sizeP \text{>=} 8 ) \&\& ( sizeQ \text{>=} 8 ) ? 3 : 1$$

to

$$max FilterLengthQ = ( sizeP \text{>=} 4 ) \&\& ( sizeQ \text{>=} 8 ) ? 3 : 1$$

If blocks P and Q are neighbored, their block boundary is aligned with a virtual boundary, and the actual filtering process may be performed only on the P side; not on the Q side. Please note that FIGS. 10 and 12 are merely examples and should not be considered as limiting. The letters “P” and “Q” in the above description and flowcharts of FIGS. 10 and 12 should be swapped. So, for FIG. 10, rather than removing the “P” related elements from the steps, the equivalent “Q” related elements could be removed. Likewise, for FIG. 12, rather than removing the “P” related elements from the steps, the equivalent “Q” related elements could be removed.

### Asymmetric Filter Signaling

In some example embodiments, information about asymmetric in-loop filtering (e.g. deblocking) at a virtual boundary may be signaled in a sequence parameter set (SPS), a picture parameter set (PPS), a picture header, and/or a slice header. The information may include, for example:
flag(s) indicting if asymmetric filtering is applied at virtual boundary,
if asymmetric filtering is applied at a virtual boundary, syntax(es) indicating on which side actual filter process is performed.

It should be understood from the above description that the example method may be extended to deblocking at a virtual boundary. That is, the max filter length on one side of a virtual boundary shall not result in fewer pixels on other side of the virtual boundary to be filtered. If checking of the max filter length on the one side of a virtual boundary will result in fewer pixels on the other side of the virtual boundary to be filtered, that checking may be removed from the filter strength (or length) decision on the other side.

The above described method may be extended to deblocking at a slice/tile/subpicture boundary. That is, the max filter length on one side of a slice/tile/subpicture boundary shall not result in fewer pixels on other side of the slice/tile boundary to be filtered. If checking of the max filter length on the one side of a slice/tile/subpicture boundary will result in fewer pixels on the other side of the slice/tile/subpicture boundary to be filtered, that checking may be removed from filter strength (or length) decision on the other side.

The above described features may be extended to deblocking at a block boundary. That is, the max filter length on one side of the block boundary shall not result in fewer pixels on other side of the block boundary to be filtered. If checking of the max filter length on the one side of a block boundary will result in fewer pixels on the other side of the block boundary to be filtered, that checking shall be removed from filter strength (or length) decision on the other side.

An example apparatus may be provided comprising: at least one processor; and at least one non-transitory memory storing instructions that, when executed with the at least one processor, cause the apparatus to: determine a virtual boundary that separates a picture, or a portion of the picture, into a first area and a second area: determine to perform filtering of at least one pixel of the first area and not perform filtering of pixels of the second area; and filter the at least one pixel of the first area with coding information of the second area.

The apparatus may be configured such that the instructions, when executed with the at least one processor, cause the apparatus to determine to perform the filtering of the at least one pixel of the first area and not perform filtering of pixels of the second area based upon a comparison of a first max filter length value for the first area relative to a second max filter length value for the second area. The apparatus may be configured such that the instructions, when executed with the at least one processor, cause the apparatus to determine to not perform filtering of pixels of the second area when the comparison indicates that fewer pixels in the second area would be filtered than at least two pixels of the first area. The apparatus may be configured such that the filtering comprises deblocking at the virtual boundary. The apparatus may be configured such that the instructions, when executed with the at least one processor, cause the apparatus to perform checking when a max filter length on a first side of the virtual boundary will result in fewer pixels on a second side of the virtual boundary to be filtered. The apparatus may be configured such that the instructions, when executed with the at least one processor, cause the apparatus to remove at least one process from a filter length decision on the second side. The apparatus may be configured such that the at least one process comprises the checking of the max filter length on the second side of the virtual boundary in the filter length decision. The at least one process may comprise a checking process of a max filter length calculated on the second side of the virtual boundary against a certain value or a number, if the checking process results in fewer pixels in the first area of the virtual boundary to be filtered. The apparatus may be configured such that the instructions, when executed with the at least one processor, cause the apparatus to remove at least one process from a filter length decision of the deblocking process on the first side. The apparatus may be configured such that the at least one process comprises a checking process of a max filter length calculated on the second side of the virtual boundary against a certain value or a number, if the checking process results in fewer pixels in the first area of the virtual boundary to be filtered. The apparatus may be configured such that the virtual boundary comprises a slice boundary or a tile boundary or a subpicture boundary. The apparatus may be configured such that the virtual boundary comprises a block boundary.

In one example embodiment the instructions, when executed with the at least one processor, cause the apparatus to determine to perform the filtering of the at least one pixel of the first area and not perform filtering of pixels of the second area based upon at least one set of pre-determined rules or at least one set of syntax in SPS, PPS, picture header or slide header, indicating where the virtual boundary is located in the picture or the portion of the picture, which side of the virtual boundary to be filtered or which side of the virtual boundary not to be filtered.

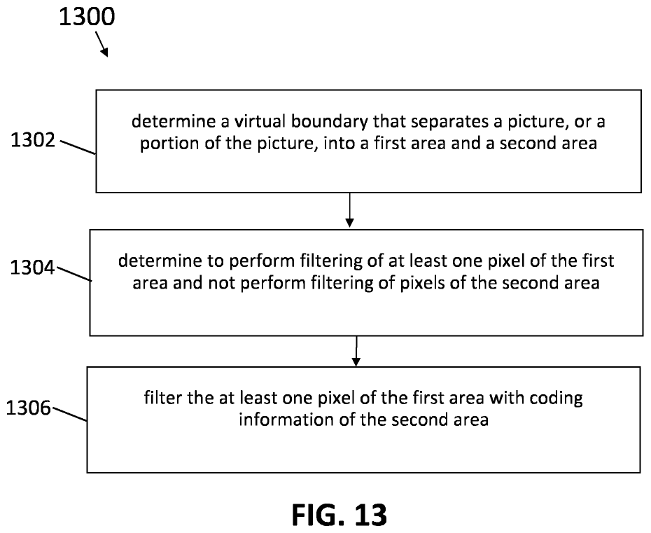

Referring also to FIG. 13, an example method 1300 may be provided comprising: determining a virtual boundary that separates a picture, or a portion of the picture, into a first area and a second area as illustrated with block 1302: determining to perform filtering of at least one pixel of the first area and not perform filtering of pixels of the second area as illustrated with block 1304; and filtering of the at least one pixel of the first area with coding information of the second area as illustrated with block 1306.

An example embodiment may be provided with a non-transitory computer readable medium comprising program instructions that, when executed with an apparatus, cause the apparatus to perform at least the following: determining a virtual boundary that separates a picture, or a portion of the picture, into a first area and a second area: determining to perform filtering of at least one pixel of the first area and not perform filtering of pixels of the second area; and filtering of the at least one pixel of the first area with coding information of the second area.

An example embodiment may be provided with an apparatus comprising: means for determining a virtual boundary that separates a picture, or a portion of the picture, into a first area and a second area; means for determining to perform filtering of at least one pixel of the first area and not perform filtering of pixels of the second area; and means for filtering of the at least one pixel of the first area with coding information of the second area.

The term “non-transitory,” as used herein, is a limitation of the medium itself (i.e., tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows. The acronyms and abbreviations may be appended with each other and/or other characters (e.g. a hyphen (-)).
3GPP 3rd generation partnership project
4G fourth generation of broadband cellular network technology
5G fifth generation cellular network technology
802.x family of IEEE standards dealing with local area networks and metropolitan area networks
ABC alternative band classifier
ALF adaptive loop filter
APS adaptation parameter set
ASIC application specific integrated circuit
BD bit depth
BIF bilateral filter
BIF-chroma bilateral filter for chroma
BIF-luma bilateral filter for luma
BO band offset
Cb blue chrominance component
CCALF or CC-ALF cross-component ALF
CCSAO cross-component SAO
CDMA code-division multiple access
CMP cube-map projection
CPE customer premises equipment
Cr red chrominance component
CTB coding tree block
CTU coding tree unit
CU coding unit
DBF deblocking filter
DCT discrete cosine transform
DSP digital signal processor
ECM enhanced compression model
EO edge offset
FDMA frequency division multiple access
FPGA field programmable gate array
GDR gradual decoding refresh
GSM global system for mobile communications
H.222.0 MPEG-2 systems, standard for the generic coding of moving pictures and associated audio information
H.26x family of video coding standards in the domain of the ITU-T
HMD head mounted display
IBC intra block copy id or ID identifier
IEC International Electrotechnical Commission
IEEE Institute of Electrical and Electronics Engineers
I/F interface
IMD integrated messaging device
IMS instant messaging service
I/O input output
IoT internet of things
IP internet protocol
ISO International Organization for Standardization
ISOBMFF ISO base media file format
ITU International Telecommunication Union
ITU-T ITU Telecommunication Standardization Sector
JTC joint technical committee
JVET joint video experts team
LEE laptop embedded equipment
LME laptop-mounted equipment
LTE long-term evolution
ML machine learning
MMS multimedia messaging service
MPEG moving picture experts group
MPEG-2 H.222/H.262 as defined by the ITU
MSE mean squared error
MV multiple views
NAL network abstraction layer
NN neural network
N/W network
PC personal computer
PDA personal digital assistant
PID packet identifier
PLC power line communication
QP quantization parameter or quarter pixel
RAM random access memory
RFID radio frequency identification
RFM reference frame memory
ROM read-only memory
Rx receiver
SAO sample adaptive offset
SMS short messaging service
SPS sequence parameter set
TCP-IP transmission control protocol-internet protocol
TDMA time divisional multiple access
TS transport stream
TU transform unit
TV television
Tx transmitter
U blue projection of a chrominance component
UICC universal integrated circuit card
UMTS universal mobile telecommunications system
USB universal serial bus
V red projection of a chrominance component
V2X vehicle-to-everything
VoIP voice over IP
VVC versatile video coding
WLAN wireless local area network
Y luminance component

1-10. (canceled)

11. An apparatus comprising:
at least one processor; and
at least one memory storing instructions that, when executed with the at least one processor, cause the apparatus to:
determine a virtual boundary that separates a picture, or a portion of the picture, into a first area and a second area;
determine to perform filtering of at least one pixel of the first area and not perform filtering of pixels of the second area; and
filter the at least one pixel of the first area with coding information of the second area.

12. The apparatus as claimed in claim 11, wherein the instructions, when executed with the at least one processor, cause the apparatus to determine to perform the filtering of the at least one pixel of the first area and not perform filtering of pixels of the second area based upon at least one set of pre-determined rules or at least one set of syntax in a sequence parameter set (SPS), a picture parameter set (PPS), a picture header, or a slide header, indicating where the virtual boundary is located in the picture or the portion of the picture, which side of the virtual boundary to be filtered or which side of the virtual boundary not to be filtered.

13. The apparatus as claimed in claim 11, wherein the filtering comprises a deblocking process at the virtual boundary.

14. The apparatus as claimed in claim 13, wherein the instructions, when executed with the at least one processor, cause the apparatus to remove at least one process from a filter length decision of the deblocking process on a first side of the virtual boundary.

15. The apparatus as claimed in claim 14, wherein the at least one process comprises a checking process of a max filter length calculated on a second side of the virtual boundary against a certain value or a number, when the checking process results in fewer pixels in the first area of the virtual boundary to be filtered.

16. The apparatus as claimed in claim 11, wherein the virtual boundary comprises a slice boundary, a tile boundary, or a subpicture boundary.

17. The apparatus as claimed in claim 11, wherein the virtual boundary comprises a block boundary.

18. A method comprising:
determining a virtual boundary that separates a picture, or a portion of the picture, into a first area and a second area;
determining to perform filtering of at least one pixel of the first area and not perform filtering of pixels of the second area; and
filtering of the at least one pixel of the first area with coding information of the second area.

19. The method as claimed in claim 18 further comprising:
determining to perform the filtering of the at least one pixel of the first area and not perform filtering of pixels of the second area based upon at least one set of pre-determined rules or at least one set of syntax in a sequence parameter set (SPS), a picture parameter set (PPS), a picture header, or a slide header, indicating where the virtual boundary is located in the picture or the portion of the picture, which side of the virtual boundary to be filtered or which side of the virtual boundary not to be filtered.

20. The method as claimed in claim 18, wherein the filtering comprises a deblocking process at the virtual boundary.

21. The method as claimed in claim 20 further comprising:
removing at least one process from a filter length decision of the deblocking process on a first side of the virtual boundary.

22. The method as claimed in claim 21, wherein the at least one process comprises a checking process of a max filter length calculated on a second side of the virtual boundary against a certain value or a number, when the checking process results in fewer pixels in the first area of the virtual boundary to be filtered.

23. The method as claimed in claim 18, wherein the virtual boundary comprises a slice boundary or a tile boundary or a subpicture boundary.

24. The method as claimed in claim 18 wherein the virtual boundary comprises a block boundary.

25. A non-transitory computer readable medium comprising instructions that, when executed with an apparatus, cause the apparatus to perform at least the following:
determining a virtual boundary that separates a picture, or a portion of the picture, into a first area and a second area; and
determining to perform filtering of at least one pixel of the first area and not perform filtering of pixels of the second area; and
filtering of the at least one pixel of the first area with coding information of the second area.

26. The non-transitory computer readable medium as claimed in claim 15, wherein the instructions, when executed with the apparatus, cause the apparatus to determine to perform the filtering of the at least one pixel of the first area and not perform filtering of pixels of the second area based upon at least one set of pre-determined rules or at least one set of syntax in a sequence parameter set (SPS), a picture parameter set (PPS), a picture header or a slide header, indicating where the virtual boundary is located in the picture or the portion of the picture, which side of the virtual boundary to be filtered or which side of the virtual boundary not to be filtered.

27. The non-transitory computer readable medium as claimed in claim 25, wherein the filtering comprises a deblocking process at the virtual boundary.

28. The non-transitory computer readable medium as claimed in claim 27, wherein the instructions, when executed with the apparatus, cause the apparatus to remove at least one process from a filter length decision of the deblocking process on a first side of the virtual boundary.

29. The non-transitory computer readable medium as claimed in claim 28, wherein the at least one process comprises a checking process of a max filter length calculated on a second side of the virtual boundary against a certain value or a number, if the checking process results in fewer pixels in the first area of the virtual boundary to be filtered.

30. The non-transitory computer readable medium as claimed in claim 26, wherein the virtual boundary comprises a slice boundary or a tile boundary or a subpicture boundary.
